(19) United States
(12) Patent Application Publication
(10) Pub. No.: US 2010/0185881 A1
(43) Pub. Date: Jul. 22, 2010

(54) SEMICONDUCTOR DEVICE INCORPORATING REGULATOR AND ELECTRIC APPARATUS INCLUDING A PLURALITY OF THE SEMICONDUCTOR DEVICES

(75) Inventor: Shigeru Morino, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/690,616

(22) Filed: Jan. 20, 2010

Related U.S. Application Data
(60) Provisional application No. 61/146,018, filed on Jan. 21, 2009.

(51) Int. Cl. G06F 1/26

(52) U.S. Cl. 713/300

(57) ABSTRACT

A semiconductor device includes a processing unit which generates a main signal, a first output terminal which outputs the main signal, a regulator which supplies power to the processing unit, a first input terminal which receives the input of a first control signal, a unit which generates a second control signal having a first level when the power is supplying to the processing unit and the first control signal has the first level and otherwise having a second level, a second output terminal which outputs the second control signal, a second input terminal which receives the input of a third control signal, and an gating unit which causes the first output terminal to output the main signal when the third control signal has the first level and stop the output of the main signal from the first output terminal when the third control signal has the second level.

### CROSS-REFERENCE TO RELATED APPLICATION

This application is based upon and claims the benefit of priority from U.S. Provisional Application No. 61/146,018 filed Jan. 21, 2009, the entire contents of which are incorporated herein by reference.

### TECHNICAL FIELD

An embodiment disclosed therein relates to a semiconductor device incorporating a regulator configured to obtain internal power for actuating internal circuits from external power and an electric apparatus including a plurality of the semiconductor devices.

### BACKGROUND

An application-specific integrated circuit (ASIC) is a type of a semiconductor device. In recent years, in the ASIC, working voltage of internal circuits tends to be set lower for microminiaturization of internal structure. Therefore, in general, the working voltage is different from the voltage of external power supplied to the ASIC. In order to cope with such a situation, there is an idea of incorporating, in the ASIC, a regulator configured to obtain internal power suitable for the working voltage from the external power.

The semiconductor device incorporating a regulator is known from for example, JP-A-11-111444, JP-A-10-150152, and JP-A-8-307894.

When an electric apparatus is configured by including a plurality of the ASICs incorporating regulators in this way, shift may occur in start timing of the ASICs because of a difference among output characteristics of the regulators. When a signal generated by one of the ASICs is input to the other ASICs, the shift of timing is undesirable. Specifically, when the ASIC on an output side is started earlier than the ASIC on an input side, a signal is input to the ASIC on the input side that is not started yet. Therefore, it is likely that the ASIC on the input side is broken.

### SUMMARY

A semiconductor device according to a first aspect of the present invention includes: a processing unit configured to perform signal processing for generating a main signal that should be supplied to other semiconductor devices; a first output terminal configured to output the main signal to the outside of the semiconductor device; a regulator configured to supply, to the processing unit, internal power obtained from external power supplied from the outside of the semiconductor device; a first input terminal configured to receive the input of a first control signal having a first or second level from the outside of the semiconductor device; a generating unit configured to generate a second control signal having the first level when the regulator is supplying the internal power to the processing unit and the first control signal input from the first input terminal has the first level and otherwise having the second level; a second output terminal configured to output the second control signal to the outside of the semiconductor device; a second input terminal configured to receive the input of a third control signal having the first or second level; and an gating unit configured to cause the first output terminal to output the main signal when the third control signal input from the second input terminal has the first level and stop the output of the main signal from the first output terminal when the third control signal has the second level.

An electric apparatus according to a second aspect of the present invention includes two semiconductor devices. Each of the semiconductor devices includes: a processing unit configured to perform at least one of signal processing for generating a main signal that should be supplied to one of the semiconductor devices and signal processing for a main signal supplied from one of the semiconductor devices; one of a first output terminal configured to output the main signal to the outside of the semiconductor device and a first input terminal configured to receive the input of the main signal as a processing target in the processing unit; a regulator configured to supply, to the processing unit, internal power obtained from external power supplied from the outside of the semiconductor device; a second input terminal configured to receive the input of a first control signal having a first or second level from the outside of the semiconductor device; a generating unit configured to generate a second control signal having the first level when the regulator is supplying the internal power to the processing unit and the first control signal input from the first input terminal has the first level and otherwise having the second level; and a second output terminal configured to output the second control signal to the outside of the semiconductor device. The semiconductor device including the processing unit configured to perform the signal processing for generating the main signal of the semiconductor devices further includes: a third input terminal configured to receive the input of a third control signal having the first or second level; and an gating unit configured to cause the first output terminal to output the main signal when the third control signal input from the third input terminal has the first level and stop the output of the main signal from the first output terminal when the third control signal has the second level. The semiconductor devices include one semiconductor device including the processing unit configured to perform the signal processing for generating the main signal and one semiconductor device including the processing unit configured to perform the signal processing for the main signal. At least one of the first output terminals included in the semiconductor devices is connected to the first input terminal included in the semiconductor device other than the semiconductor device including that first output terminal. The external power is input, as the first control signal, to the second input terminal included in a first semiconductor device as one of the semiconductor devices. The second output terminal included in a second semiconductor device as one of the semiconductor devices different from the first semiconductor device is connected to all the third input terminals included in at least one of the semiconductor devices. The second output terminal included in the first semiconductor device is connected to the second input terminal included in the second semiconductor device.

An electric apparatus according to a third aspect of the present invention includes three or more semiconductor devices. Each of the semiconductor devices includes: a processing unit configured to perform at least one of signal processing for generating a main signal that should be supplied to any one of the semiconductor devices and signal processing for a main signal supplied from any one of the semiconductor devices; one of a first output terminal configured to output the main signal to the outside of the semiconductor device and a first input terminal configured to receive the input of the main signal as a processing target in the processing unit; a regulator configured to supply, to the processing unit, internal power obtained from external power supplied from the outside of the semiconductor device; a second input terminal configured to receive the input of a first control signal having a first or second level from the outside of the semiconductor device; a generating unit configured to generate a second control signal having the first level when the regulator is supplying the internal power to the processing unit and the first control signal input from the first input terminal has the first level and otherwise having the second level; and a second output terminal configured to output the second control signal to the outside of the semiconductor device. The semiconductor device including the processing unit configured to perform the signal processing for generating the main signal among the semiconductor devices further includes: a third input terminal configured to receive the input of a third control signal having the first or second level; and an gating unit configured to cause the first output terminal to output the main signal when the third control signal input from the third input terminal has the first level and stop the output of the main signal from the first output terminal when the third control signal has the second level. At least one of the first output terminals included in the semiconductor devices is connected to the first input terminal included in the semiconductor device other than the semiconductor device including that first output terminal. The semiconductor devices include at least one semiconductor device including the processing unit configured to perform the signal processing for generating the main signal and at least one semiconductor device including the processing unit configured to perform the signal processing for the main signal. The external power is input, as the first control signal, to the second input terminal included in a first semiconductor device as one of the semiconductor devices. The second output terminal included in a second semiconductor device as one of the semiconductor devices different from the first semiconductor device is connected to all the third input terminals included in at least some of the semiconductor devices. A plurality of the second output terminals respectively included in a plurality of the semiconductor devices other than the second semiconductor device among the semiconductor devices are respectively connected to a plurality of the second input terminals included in a plurality of the semiconductor devices other than the first semiconductor device among the semiconductor devices.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a part of an ASIC according to an embodiment of the present invention;

FIG. 2 is a block diagram of a part of an electric apparatus mounted with a pair of the ASICs shown in FIG. 1;

FIG. 3 is a block diagram of a part of an electric apparatus mounted with a trio of the ASICs shown in FIG. 1;

FIG. 4 is a block diagram of a part of an electric apparatus configured by modifying a part of the electric apparatus shown in FIG. 3; and

FIG. 5 is a block diagram of an ASIC configured by modifying the ASIC shown in FIG. 1.

### DETAILED DESCRIPTION

An embodiment of the present invention is explained below with reference to the accompanying drawings.

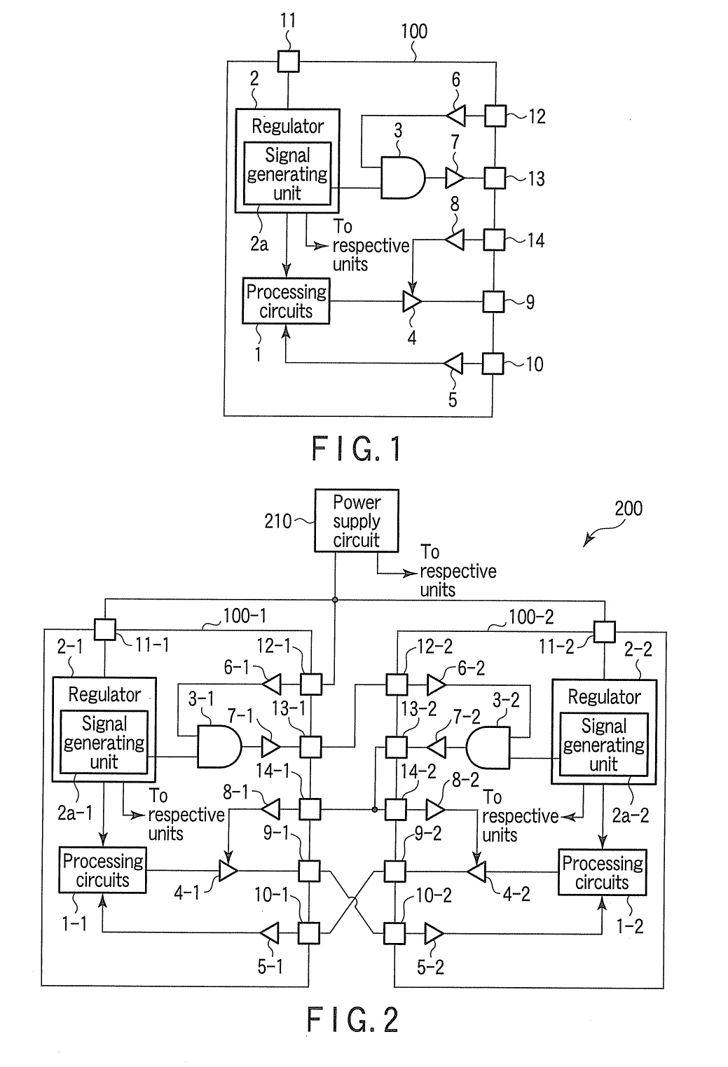

FIG. 1 is a block diagram of a part of an ASIC 100 according to this embodiment.

The ASIC 100 includes a processing circuit 1, a regulator 2, an AND gate 3, buffers 4, 5, 6, 7, and 8, and terminals 9, 10, 11, 12, 13, and 14.

The processing circuit 1 performs signal processing for generating a signal (hereinafter referred to as main signal) that should be supplied to other ASIC. The processing circuit 1 also performs signal processing for main signals supplied from the other ASICs. The main signal generated by the processing circuit 1 is output from the terminal 9 to the outside of the ASIC 100 via the buffer 4. A main signal supplied from the other ASIC is input to the processing circuit 1 from the terminal 10 via the buffer 5.

The regulator 2 generates internal power from external power supplied via the terminal 11. The regulator 2 changes the voltage of the internal power to working voltage of internal circuits of the ASIC 100 such as the processing circuit 1, the AND gate 3, and the buffers 4, 5, 6, 7, and 8. The regulator 2 supplies the internal power to the internal circuits of the ASIC 100. The internal circuits of the ASIC 100 operate with the internal power.

The regulator 2 includes a signal generating unit 2a. The signal generating unit 2a generates a supply state signal. The supply state signal is at a high level when the regulator 2 is outputting the internal power and is otherwise at a low level.

The AND gate 3 has two input terminals. The supply state signal is input to one of the input terminals. The terminal 12 is connected to the other input terminal via the buffer 6. The AND gate 3 calculates an AND of signals respectively input to the two input terminals. An output terminal of the AND gate 3 is connected to the terminal 13 via the buffer 7.

The buffers 4, 5, 6, 7, and 8 adjust a level of an input signal. Specifically, the buffers 4, 5, 6, 7, and 8 output a level specified as the low level when the level of the input signal is within a range corresponding to the low level and output a level specified as the high level when the level of the input signal is within a range corresponding to the high level. The low level and the high level are common among the buffers 6, 7, and 8. However, the low level and the high level may be common or may be separate between the other buffers.

An element of a three-state type is adopted as the buffer 4. Specifically, the buffer 4 selectively forms a state for setting an output terminal to high impedance besides two states for setting the terminal 9 to the low level and the high level. The buffer 4 sets the terminal 9 to the low level or the high level when an enable terminal is at the high level and sets the output terminal to high impedance when the enable terminal is at the low level. A signal input from the terminal 14 is supplied to the enable terminal via the buffer 8.

The ASIC 100 is suitably mounted on an electric apparatus while being connected to other ASIC of the same type.

FIG. 2 is a block diagram of a part of an electric apparatus 200 mounted with a pair of the ASICs 100. Components same as those shown in FIG. 1 are denoted by the same reference numerals and signs and detailed explanation of the components is omitted. However, in order to facilitate distinction of the two ASICS 100, in FIG. 2 and the following explanation concerning FIG. 2, one of the two ASICs 100 is shown and referred to as ASIC 100-1 and the other is shown and referred to as ASIC 100-2. Reference numerals and signs assigned to components included in the ASIC 100-1 are also affixed with a suffix “−1”. Reference numerals and signs assigned to components included in the ASIC 100-2 are also affixed with a suffix “−2”.

The electric apparatus 200 includes the ASICs 100-1 and 100-2 and a power supply circuit 210.

The power supply circuit 210 outputs electric power for actuating the ASICs 100-1 and 100-2 and other not-shown components in the electric apparatus 200. The electric power output by the power supply circuit 210 is supplied from terminals 11-1 and 11-2 to the ASICs 100-1 and 100-2. The electric power supplied to the ASICs 100-1 and 100-2 by the power supply circuit 210 has voltage different from that of internal power of the ASICs 100-1 and 100-2. Specifically, the power supply circuit 210 only has to directly supply, to the ASICs 100-1 and 100-2, electric power generated at voltage suitable for actuating the components other than the ASICs 100-1 and 100-2.

The electric power output by the power supply circuit 210 is supplied to the ASIC 100-1 from a terminal 12-1 as well.

A connection relation between the ASIC 100-1 and the ASIC 100-2 is as follows:

a terminal 9-1 and a terminal 10-2;

a terminal 10-1 and a terminal 9-2;

a terminal 13-1 and a terminal 12-2; and

a terminal 14-1 and terminals 13-2 and 14-2.

Characteristic operation in this embodiment in the electric apparatus 200 is explained below.

When power supply from the power supply circuit 210 to the ASICs 100-1 and 100-2 is started, regulators 2-1 and 2-2 are respectively activated and start output of internal power. However, because of a difference between output characteristics of the regulators 2-1 and 2-2, timing for starting to output the internal power of each of the regulators 2-1 and 2-2 may shift.

A signal generating unit 2a-1 sets a supply state signal to the low level when the regulator 2-1 is not outputting the internal power. On the other hand, one input terminal of an AND gate 3-1 changes to the high level according to the start of the power supply from the power supply circuit 210. However, before the regulator 2-1 starts to output the internal power, the other input terminal of the AND gate 3-1 is at the low level because the supply state signal is at the low level. Therefore, an output of the AND gate 3-1 is also at the low level.

Since the terminal 13-1 and the terminal 12-2 are connected, the output of the AND gate 3-1 is input to one input terminal of the AND gate 3-2 via a buffer 7-1, the terminals 13-1 and 12-2, and a buffer 6-2. A supply state signal output by a signal generating unit 2a-2 is input to the other input terminal of the AND gate 3-2. However, when the output of the AND gate 3-1 is at the low level, an output level of the AND gate 3-2 is at the low level irrespectively of a level of the supply state signal output by the signal generating unit 2a-2.

The signal generating unit 2a-1 sets the supply state signal to the high level when the regulator 2-1 is outputting the internal power. When the regulator 2-1 is outputting the internal power, since the power supply from the power supply circuit 210 is always performed, one input terminal of the AND gate 3-1 is at the high level. Consequently, when the supply state signal output by the signal generating unit 2a-1 changes to the high level, the output of the AND gate 3-1, i.e., one input terminal of the AND gate 3-2 changes to the high level.

The signal generating unit 2a-2 sets the supply state signal to the low level when the regulator 2-2 is not outputting the internal power. The signal generating unit 2a-1 sets the supply state signal to the high level when the regulator 2-2 is outputting the internal power. Consequently, even when the output of the AND gate 3-1 is at the high level, the output of the AND gate 3-2 is at the low level when the regulator 2-2 is not outputting the internal power. When the output of the AND gate 3-1 is at the high level and the regulator 2-2 is outputting the internal power, the output of the AND gate 3-2 changes to the high level.

Consequently, the output of the AND gate 3-2 is at the high level only when both the regulators 2-1 and 2-2 are outputting the internal power and is otherwise at the low level. The output of the AND gate 3-2 is input to an enable terminal of a buffer 4-1 via a buffer 7-2, the terminal 13-2, the terminal 14-1, and a buffer 8-1 and input to an enable terminal of a buffer 4-2 via the buffer 7-2, the terminal 13-2, the terminal 14-2, and a buffer 8-2.

The buffer 4-1 sets an output terminal thereof to high impedance when the enable terminal thereof is at the low level. The buffer 4-2 sets an output terminal thereof to high impedance when the enable terminal thereof is at the low level. Consequently, both the buffers 4-1 and 4-2 set the output terminals to high impedance except when both the regulators 2-1 and 2-2 are outputting the internal power. When the internal power is supplied from the regulators 2-1 and 2-2, the processing circuits 1-1 and 1-2 are activated and can generate and output main signals. However, even if one of the processing circuits 1-1 and 1-2 outputs the main signal, when one of the regulators 2-1 and 2-2 is not outputting the internal power, the main signal is blocked by the buffers 4-1 and 4-2 and is not output from the terminals 9-1 and 9-2. When both the regulators 2-1 and 2-2 are outputting the internal power, the main signal output by one of the processing circuits 1-1 and 1-2 is output from the terminals 9-1 and 9-2 via the buffers 4-1 and 4-2. The main signal output from the processing circuit 1-1 at this point is output from the terminal 9-1 and then input to the processing circuit 1-2 via the terminal 10-2 and a buffer 5-2. The main signal output from the processing circuit 1-2 is output from the terminal 9-2 and then input to the processing circuit 1-1 via the terminal 10-1 and a buffer 5-1.

As explained above, in the electric apparatus 200, only in a state in which the internal power is supplied from the regulators 2-1 and 2-2 in both the ASICs 100-1 and 100-2, the main signal is supplied from one of the ASICs 100-1 and 100-2 to the other. Therefore, the main signal is not applied to an element to which the internal power is not supplied. It is possible to prevent the ASIC to which the internal power is not supplied from being broken.

The electric apparatus 200 that can attain the effects explained above can be configured by combining a pair of the ASICs 100 according to this embodiment.

In some cases, a high-level signal is input to the buffers 6 and 8 when the internal power is not supplied. However, if voltage equivalent to the high level of the signal input to the buffers 6 and 8 is set lower than input withstanding voltage in a no-power supply state of the buffers 6 and 8, the buffers 6 and 8 are not broken even in such a situation. When the voltage equivalent to the high level of the signal input to the buffers 6 and 8 is set higher than the input withstanding voltage in the no-power supply state of the buffers 6 and 8, a fail-safe type element only has to be used as the buffers 6 and 8. The fail-safe type element is an element having a self-protection function against an input of voltage higher than the input withstanding voltage.

It is also possible to configure an electric apparatus mounted with a trio or more of the ASICs 100.

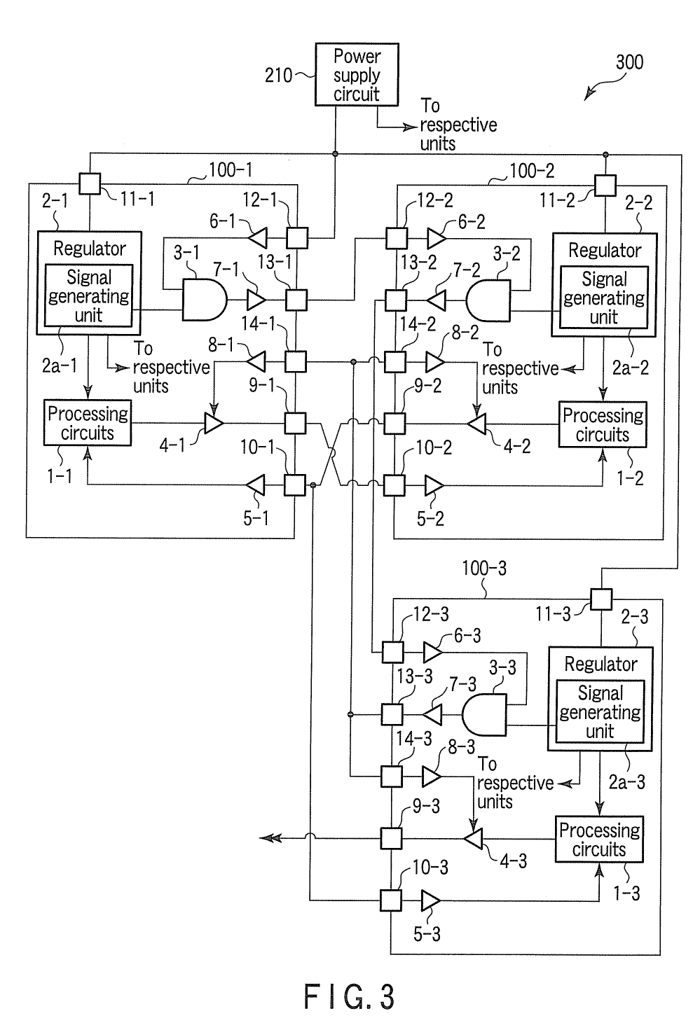

FIG. 3 is a block diagram of a part of an electric apparatus 300 mounted with a trio of the ASICs 100. Components same as those shown in FIGS. 1 and 2 are denoted by the same reference numerals and signs and detailed explanation of the components is omitted. However, in order to facilitate distinction of the three ASICS 100, in FIG. 3 and the following explanation concerning FIG. 3, the three ASICs 100 are respectively shown and referred to as ASIC 100-1, ASIC 100-2, and ASIC 100-3. Reference numerals and signs assigned to components included in the ASIC 100-1 are also affixed with a suffix “−1”. Reference numerals and signs assigned to components included in the ASIC 100-2 are also affixed with a suffix “−2”. Reference numerals and signs assigned to components included in the ASIC 100-3 are also affixed with a suffix “−3”.

The electric apparatus 300 includes the ASICs 100-1, 100-2, and 100-3 and a power supply circuit 210. Electric power output by the power supply circuit 210 is supplied from terminals 11-1, 11-2, and 11-3 to the ASICs 100-1, 100-2, and 100-3. The electric power output by the power supply circuit 210 is supplied to the ASIC 100-1 from the terminal 12-1 as well.

A connection relation among the ASICs 100-1, 100-2, and 100-3 is as follows:

the terminal 9-1 and the terminal 10-2;

the terminal 10-1 and terminals 9-2 and 10-3;

the terminal 13-1 and the terminal 12-2; and

the terminal 14-1 and terminals 13-2, 14-2, 13-3, and 13-4.

According to the connection relation, in the electric apparatus 300, AND gates 3-1, 3-2, and 3-3 are cascaded. An output of the AND gate 3-1 located at the tail is input to enable terminals of buffers 4-1, 4-2, and 4-3. Consequently, only when all input terminals of the AND gates 3-1, 3-2, and 3-3 change to the high level, i.e., only in a state in which the internal power is supplied from all the regulators 2-1, 2-2, and 2-3, main signals are output from the ASICs 100-1, 100-2, and 100-3 to the outside thereof.

A plurality of ASICs mounted on an electric apparatus do not need to have a common configuration.

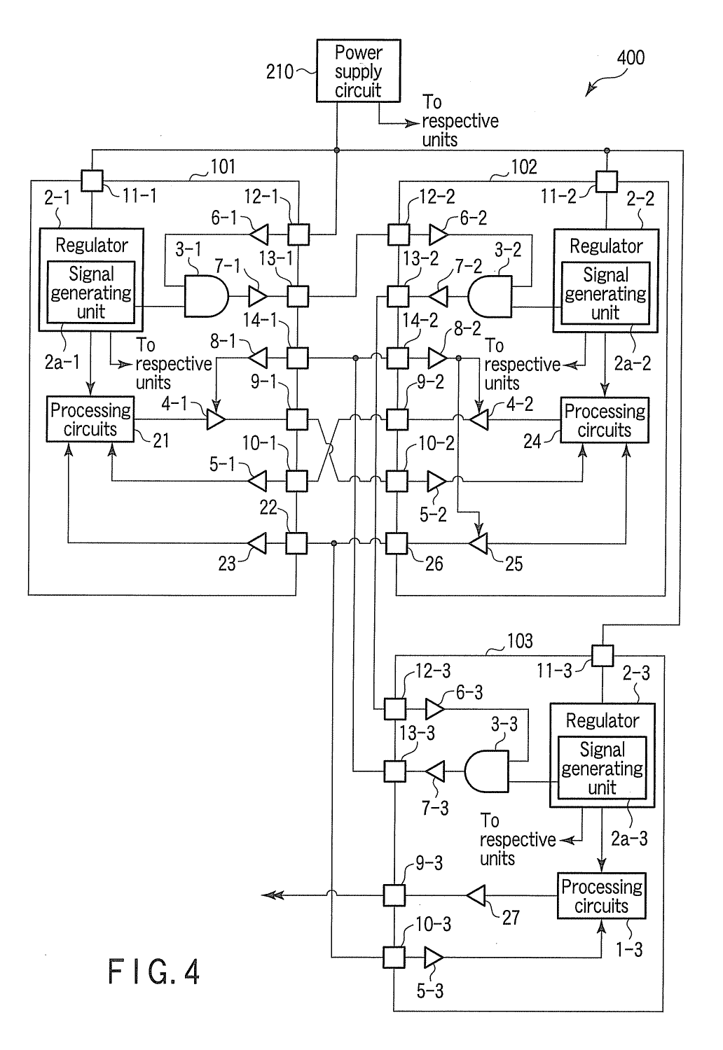

FIG. 4 is a block diagram of a part of an electric apparatus 400 configured by modifying a part of the electric apparatus 300. Components same as those shown in FIG. 3 are denoted by the same reference numerals and signs and detailed explanation of the components is omitted.

The electric apparatus 400 includes ASICs 101, 102, and 103 and the power supply circuit 201.

Specifically, the electric apparatus 400 includes the ASICs 101, 102, and 103 instead of the ASICs 100-1, 100-2, and 100-3. The ASIC 101 is configured by modifying a part of the ASIC 100-1. The ASIC 102 is configured by modifying a part of the ASIC 100-2. The ASIC 103 is configured by modifying a part of the ASIC 100-3.

The ASIC 101 includes a processing circuit 21 instead of the processing circuit 1-1 in the ASIC 100-1 and further includes a terminal 22 and a buffer 23.

The processing circuit 21 has, in addition to the functions of the processing circuit 1-1, a function of processing a main signal input from the terminal 22 and given via the buffer 23 separately from the main signal input from the terminal 10-1.

Consequently, the ASIC 101 can receive the input of a plurality of main signals and process the main signals.

The ASIC 102 includes a processing circuit 24 instead of the processing circuit 1-2 in the ASIC 100-2 and further includes a buffer 25 and a terminal 26.

The processing circuit 24 has, in addition to the functions of the processing circuit 1-2, a function of generating a separate new main signal. This main signal is output from the terminal 26 to the outside of the ASIC 102 via the buffer 25. A three-state type element is used as the buffer 25. An output of the buffer 8-2 is input to an enable terminal of the buffer 25.

Consequently, the ASIC 102 can generate a plurality of main signals and output the main signals. All the main signals can be stopped from being output until internal power is supplied in all the ASICs 101 to 103.

The ASIC 103 includes a buffer 27 instead of the buffer 4-3 in the ASIC 100-3 and does not include the buffer 8-3 and the terminal 14-3.

The buffer 27 is a two-state type element and does not have a function of setting an output terminal to high impedance.

Consequently, the ASIC 103 can output the main signal even if the internal power is not supplied in one of the ASICs 101 and 102. The main signal output by the ASIC 103 in this way is input to the circuits other than the ASICs 101 and 102. The circuits to which the main signal output by the ASIC 103 is input are circuits that are always operating in a state in which the regulator 2-3 supplies the internal power or have input withstanding voltage higher than the high level of the main signal output by the ASIC 103.

Various modifications of this embodiment explained below are possible.

(1) If a regulator generates voltage equivalent to a high-level input of an AND element, the output of the voltage may be input to the AND element as a supply state signal. In this case, a supply-state-signal generating unit can be omitted.

(2) The supply-state-signal generating unit may be provided to be externally attached to the regulator. As an example, a circuit configured to receive power supply from the regulator and output a signal of voltage equivalent to the high-level input of the AND element only has to be provided.

(3) An element of a type different from the three-state type may be used as the buffers 4 and 25. For example, an analog switch including a field-effect transistor (FET) can be used.

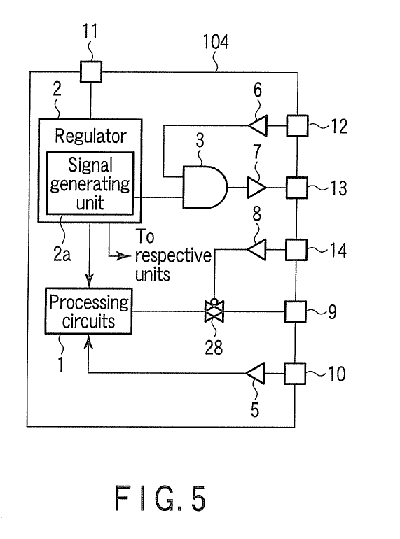

FIG. 5 is a block diagram of an ASIC 104 configured by modifying the ASIC 100 shown in FIG. 1.

The ASIC 104 includes an analog switch 28 instead of the buffer 4 in the ASIC 100. The analog switch 28 includes a control terminal. An output terminal of the buffer 8 is connected to the control terminal. The analog switch 28 includes an FET and an inverter. The analog switch 28 inputs a signal, which is input to the control terminal, to a gate of the FET after inverting the logic of the signal with the inverter. Only when the signal input to the gate is at the low level, i.e., only when an output signal of the buffer 8 is at the high level, the FET allows the main signal output from the processing circuit 1 to pass to the terminal 9.

(4) When an electric apparatus is configured by including a plurality of ASICs, some of the ASICs may be ASICs that do not include a third input terminal and a third input element and in which processing circuits perform only processing for generating main signals and do not has a function of processing main signals given from other ASICs.

(5) When an electric apparatus is configured by including a plurality of ASICs, some of the ASICs may be ASICs that do not include a first output terminal, a first output element, a second input terminal, and a second input element and in which processing circuits perform only processing of main signals given from the other ASICs and do not have a processing function for generating a main signal given to the other ASICs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor device comprising:
a processing unit configured to perform signal processing for generating a main signal that should be supplied to other semiconductor devices;
a first output terminal configured to output the main signal to the outside of the semiconductor device;
a regulator configured to supply, to the processing unit, internal power obtained from external power supplied from the outside of the semiconductor device;
a first input terminal configured to receive the input of a first control signal having a first or second level from the outside of the semiconductor device;
a generating unit configured to generate a second control signal having the first level when the regulator is supplying the internal power to the processing unit and the first control signal input from the first input terminal has the first level and otherwise having the second level;
a second output terminal configured to output the second control signal to the outside of the semiconductor device;
a second input terminal configured to receive the input of a third control signal having the first or second level; and
an gating unit configured to cause the first output terminal to output the main signal when the third control signal input from the second input terminal has the first level and stop the output of the main signal from the first output terminal when the third control signal has the second level.

2. The semiconductor device of claim 1, wherein
the generating unit further includes:
a unit configured to generate a supply state signal having the first level when the regulator supplies the internal power to the processing unit and otherwise having the second level; and
an AND circuit configured to calculate an AND of the first control signal input from the first input terminal and the supply state signal, and
the generating unit sets an output of the AND circuit as the second control signal.

3. The semiconductor device of claim 1, wherein
the processing unit outputs the main signal as a signal having a third or fourth level, and
the gating unit is an output element of a three-state type configured to selectively form a state for setting the first output terminal to a fifth level when the main signal output from the processing unit is at the third level, a state for setting the first output terminal to a sixth level when the main signal output from the processing unit is at the fourth level, and a state for setting the first output terminal to high impedance.

4. The semiconductor device of claim 1, further comprising an input element configured to give the control signal, which is input from the first input terminal, to the generating unit after adjusting a signal level of the first control signal, wherein
the input element has a self-protection function against voltage generated in the first input terminal in a state in which electric power for operation is not supplied thereto.

5. The semiconductor device of claim 1, further comprising an input element configured to give the second control signal, which is input from the second input terminal, to the gating unit after adjusting a signal level of the second control signal, wherein
the input element has a self-protection function against voltage generated in the second input terminal in a state in which electric power for operation is not supplied thereto.

6. An electric apparatus comprising two semiconductor devices, wherein
each of the semiconductor devices includes:
a processing unit configured to perform at least one of signal processing for generating a main signal that should be supplied to one of the semiconductor devices and signal processing for a main signal supplied from one of the semiconductor devices;
one of a first output terminal configured to output the main signal to the outside of the semiconductor device and a first input terminal configured to receive the input of the main signal as a processing target in the processing unit;
a regulator configured to supply, to the processing unit, internal power obtained from external power supplied from the outside of the semiconductor device;
a second input terminal configured to receive the input of a first control signal having a first or second level from the outside of the semiconductor device;
a generating unit configured to generate a second control signal having the first level when the regulator is supplying the internal power to the processing unit and the first control signal input from the second input terminal has the first level and otherwise having the second level; and
a second output terminal configured to output the second control signal to the outside of the semiconductor device,
the semiconductor device including the processing unit configured to perform the signal processing for generating the main signal of the semiconductor devices further includes:
a third input terminal configured to receive the input of a third control signal having the first or second level; and
an gating unit configured to cause the first output terminal to output the main signal when the third control signal input from the third input terminal has the first level and stop the output of the main signal from the first output terminal when the third control signal has the second level,
the semiconductor devices include one semiconductor device including the processing unit configured to perform the signal processing for generating the main signal and one semiconductor device including the processing unit configured to perform the signal processing for the main signal,
at least one of the first output terminals included in the semiconductor devices is connected to the first input terminal included in the semiconductor device other than the semiconductor device including that first output terminal,
the external power is input, as the first control signal, to the second input terminal included in a first semiconductor device as one of the semiconductor devices,
the second output terminal included in a second semiconductor device as one of the semiconductor devices different from the first semiconductor device is connected to all the third input terminals included in at least one of the semiconductor devices, and the second output terminal included in the first semiconductor device is connected to the second input terminal included in the second semiconductor device.

7. An electric apparatus comprising three or more semiconductor devices, wherein
each of the semiconductor devices includes:
a processing unit configured to perform at least one of signal processing for generating a main signal that should be supplied to any one of the semiconductor devices and signal processing for a main signal supplied from any one of the semiconductor devices;
one of a first output terminal configured to output the main signal to the outside of the semiconductor device and a first input terminal configured to receive the input of the main signal as a processing target in the processing unit;
a regulator configured to supply, to the processing unit, internal power obtained from external power supplied from the outside of the semiconductor device;
a second input terminal configured to receive the input of a first control signal having a first or second level from the outside of the semiconductor device;
a generating unit configured to generate a second control signal having the first level when the regulator is supplying the internal power to the processing unit and the first control signal input from the second input terminal has the first level and otherwise having the second level; and
a second output terminal configured to output the second control signal to the outside of the semiconductor device,
the semiconductor device including the processing unit configured to perform the signal processing for generating the main signal among the semiconductor devices further includes:
a third input terminal configured to receive the input of a third control signal having the first or second level; and
an gating unit configured to cause the first output terminal to output the main signal when the third control signal input from the third input terminal has the first level and stop the output of the main signal from the first output terminal when the third control signal has the second level,
at least one of the first output terminals included in the semiconductor devices is connected to the first input terminal included in the semiconductor device other than the semiconductor device including that first output terminal,
the semiconductor devices include at least one semiconductor device including the processing unit configured to perform the signal processing for generating the main signal and at least one semiconductor device including the processing unit configured to perform the signal processing for the main signal,
the external power is input, as the first control signal, to the second input terminal included in a first semiconductor device as one of the semiconductor devices,
the second output terminal included in a second semiconductor device as one of the semiconductor devices different from the first semiconductor device is connected to all the third input terminals included in at least some of the semiconductor devices, and
a plurality of the second output terminals respectively included in a plurality of the semiconductor devices other than the second semiconductor device among the semiconductor devices are respectively connected to a plurality of the second input terminals included in a plurality of the semiconductor devices other than the first semiconductor device among the semiconductor devices.
